(19) United States
(12) Patent Application Publication
(10) Pub. No.: US 2026/0095938 A1
(43) Pub. Date: Apr. 2, 2026

(54) METHODS, PROCEDURES, AND APPARATUS TO DESIGN AND APPLY OPTIMAL DISTRIBUTED RESOURCE UNIT (DRU)-LONG TRAINING FIELD (LTF) SEQUENCES IN WI-FI

(71) Applicant: InterDigital Patent Holdings, Inc., Wilmington, DE (US)

(72) Inventors: Mahmoud Saad, Montreal (CA); Mrugen Deshmukh, Raleigh, NC (US); Ying Wang, Easton, PA (US); Hanqing Lou, Syosset, NY (US); Rui Yang, Greenlawn, NY (US)

(73) Assignee: InterDigital Patent Holdings, Inc., Wilmington, DE (US)

(21) Appl. No.: 18/902,560

(22) Filed: Sep. 30, 2024

(51) Int. Cl. H04W 74/0808; H04L 5/00

(52) U.S. Cl. CPC H04W 74/0808; H04L 5/0094

(57) ABSTRACT

In an example, a non-AP STA determines a distribution bandwidth and a distributed resource unit (DRU) allocation from a plurality of DRU allocations. Further, each of the plurality of DRU allocations includes respective subcarriers. Also, subcarriers of the determined DRU allocation are interleaved with subcarriers of one or more other DRU allocations of the plurality of DRU allocations, across the distribution bandwidth, and the determined DRU allocation includes 52 subcarriers. The STA transmits a frame, to an AP, using the determined DRU allocation, the frame including a physical layer (PHY) preamble including a DRU LTF sequence, wherein the DRU LTF includes: −1, −1, −1, 1, 1, 1, −1, −1, −1, 1, −1, −, −1, 1, −1, 1, 1, 1, −1, 1, 1, −1, 1, 1, −1, 1.

### BACKGROUND

A wireless local area network (WLAN) in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA.

The traffic between STAs within a BSS may be considered as or referred to as peer-to-peer traffic. The peer-to-peer traffic may be sent between, for example, directly between, the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP; and the STAs, for example, all of the STAs, within or using the IBSS may communicate directly with each other. The IBSS mode of communication may sometimes be referred to herein as an “ad-hoc” mode of communication.

Using the 802.11ac infrastructure mode of operation, the AP may transmit a beacon on a fixed channel, usually the primary channel. This channel may be 20 megahertz (MHz) wide and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the primary channel. If the channel is detected to be busy, the STA backs off. Hence only one STA may transmit any given time, frequency, and space resources in each BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz, and 80 MHz, channels are formed by combining contiguous 20 MHz channels similar to 802.11n described above. A 160 MHz channel may be formed either by combining 8 contiguous 20 MHz channels, or by combining two non-contiguous 80 MHz channels, which may also be referred to as an 80+80 configuration.

### SUMMARY

In an example, a non-AP STA determines a distribution bandwidth and a distributed resource unit (DRU) allocation from a plurality of DRU allocations. Further, each of the plurality of DRU allocations includes respective subcarriers. Also, subcarriers of the determined DRU allocation are interleaved with subcarriers of one or more other DRU allocations of the plurality of DRU allocations, across the distribution bandwidth, and the determined DRU allocation includes 52 subcarriers. The STA transmits a frame, to an AP, in the determined DRU allocation, including a physical layer (PHY) preamble including a DRU long training field (LTF) sequence, wherein the DRU LTF includes: −1, −1, −1, 1, 1, 1, −1, −1, −1, 1, −1, −1, −1, 1, −1, 1, 1, 1, −1, 1, 1, −1, 1, 1, −1, 1.

Additionally or alternatively, the −1, −1, −1, 1, 1, 1, −1, −1, −1, 1, −1, −1, −1, 1, −1, 1, 1, 1, −1, 1, 1, −1, 1, 1, −1, 1 may be a first component of the DRU LTF. Further, the determined DRU allocation may include 52 subcarriers. In an example, the frame may include a second component on a condition that the DRU allocation includes a first tone distribution pattern, a second tone distribution pattern, or a third tone distribution pattern. For example, the DRU allocation may be 52DRU20_1. Additionally or alternatively, the DRU allocation may be 52DRU20_2. Additionally or alternatively, the DRU allocation may be 52DRU20_3. Additionally or alternatively, the second component is: 1, −1, 1, −1, −1, 1, −1, 1, 1, −1, 1, 1, 1, −1, 1, 1, 1, 1, −1, 1, −1, −1, −1, 1, −1, −1.

Additionally or alternatively, on a condition that the DRU allocation includes a fourth tone distribution pattern, the DRU LTF includes: −1, −1, 1, 1, −1, −1, −1, 1, 1, −1, 1, 1, 1, 1, 1, 1, −1, −1, 1, −1, 1, 1, 1, −1, 1, −1 as a second component of the DRU LTF. For example, the DRU allocation may be 52DRU20_4.

Additionally or alternatively, the DRU allocation includes 26 subcarriers and the DRU allocation includes one of: a first tone distribution pattern (26DRU20_1), a second tone distribution pattern (26DRU20_2), a third tone distribution pattern (26DRU20_3), a fourth tone distribution pattern (26DRU20_4), a sixth tone distribution pattern (26DRU20_6), or a seventh tone distribution pattern (26DRU20_7). Additionally or alternatively, the DRU allocation includes 106 subcarriers and the DRU allocation includes a first tone distribution pattern (106DRU20_1) and a second tone distribution pattern (106DRU20_2).

In another example, the non-AP STA determines a distribution bandwidth and a DRU allocation from a plurality of DRU allocations in a tone plan. Further, each of the plurality of DRU allocations includes respective subcarriers. Also, subcarriers of the determined DRU allocation are interleaved with subcarriers of one or more other DRU allocations of the plurality of DRU allocations, across the distribution bandwidth. Moreover, the STA transmits a frame, to an AP, using the determined DRU allocation, the frame including a PHY preamble including a DRU LTF sequence. Further, the DRU LTF includes a first component and at least a second component of length 26. The first component of length 26 and the at least second component of length 26 are based on a size of the determined DRU allocation. The first component is a sequence of length 26 that is optimal for the most 26 tone distribution patterns in the tone plan.

Additionally or alternatively, the distribution bandwidth is 20 MHz. Additionally or alternatively, the distribution bandwidth is 40 MHz. Additionally or alternatively, the distribution bandwidth is 80 MHz.

Additionally or alternatively, the determined DRU allocation includes 52 subcarriers. Additionally or alternatively, the determined DRU allocation includes 106 subcarriers and the DRU LTF includes a third component of length 26 and a fourth component of length 26. Additionally or alternatively, the DRU LTF further includes: {1, −1}. Additionally or alternatively, the DRU LTF further includes: {−1, −1}.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a flowchart diagram illustrating determination of the optimal long training field (LTF) sequences for a 26 tone distributed resource unit (DRU) over a 20 megahertz (MHz) distribution bandwidth; and

FIG. 3 is a flowchart diagram illustrating determination of the optimal LTF sequences for a 52 tone DRU over a 20 MHz distribution bandwidth.

### DETAILED DESCRIPTION

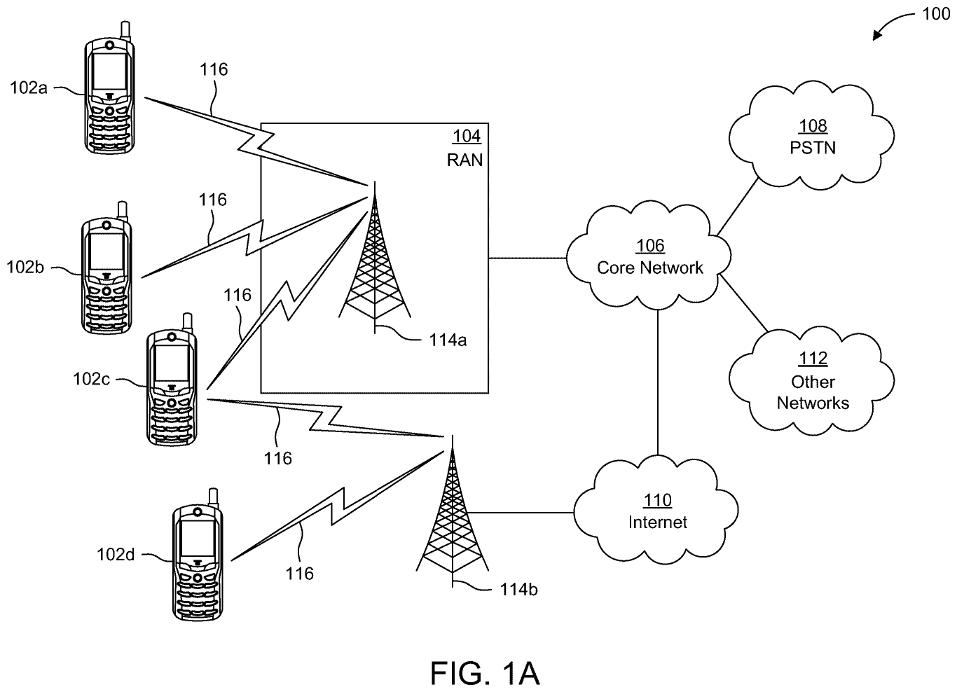

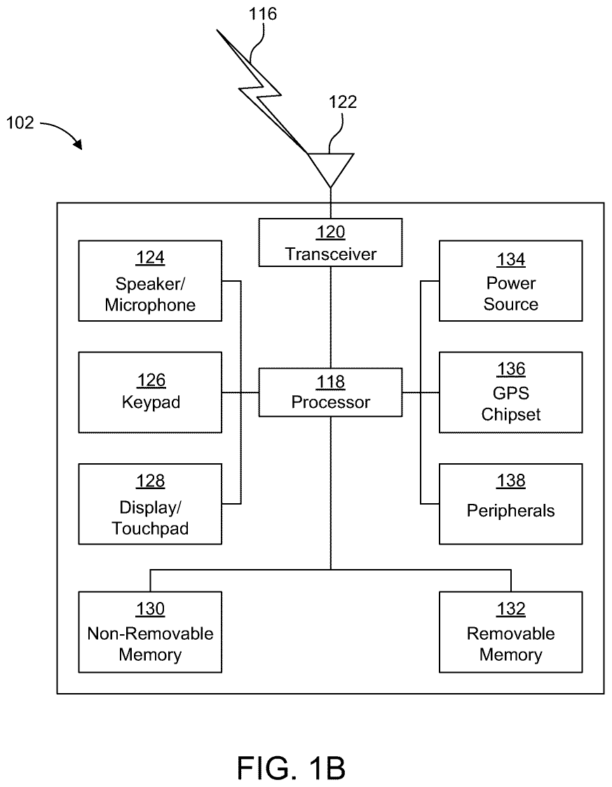

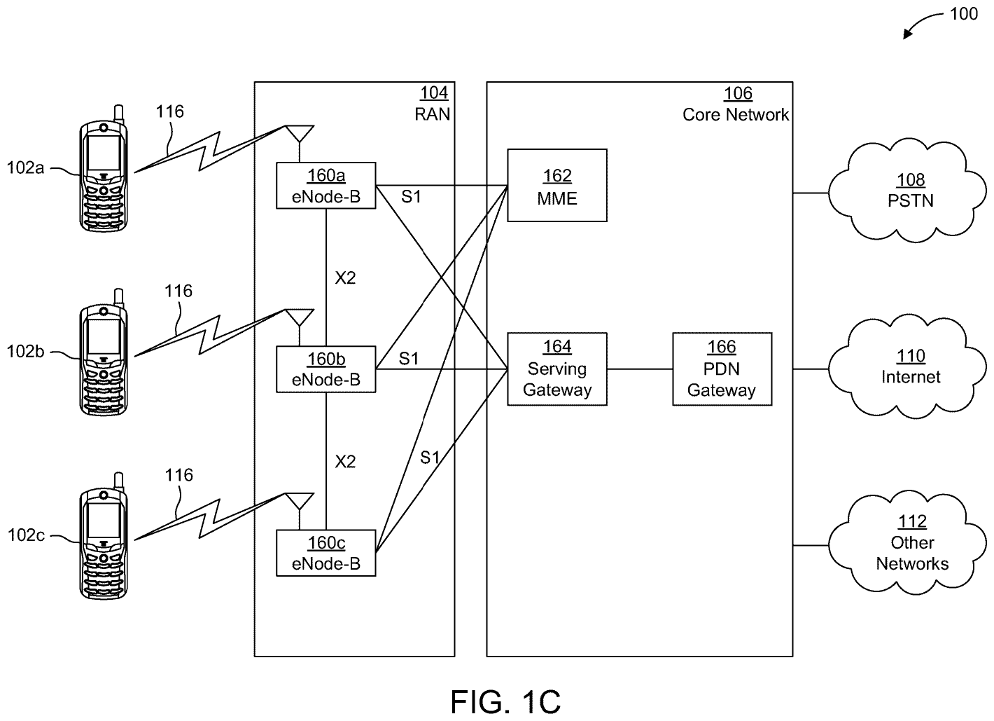

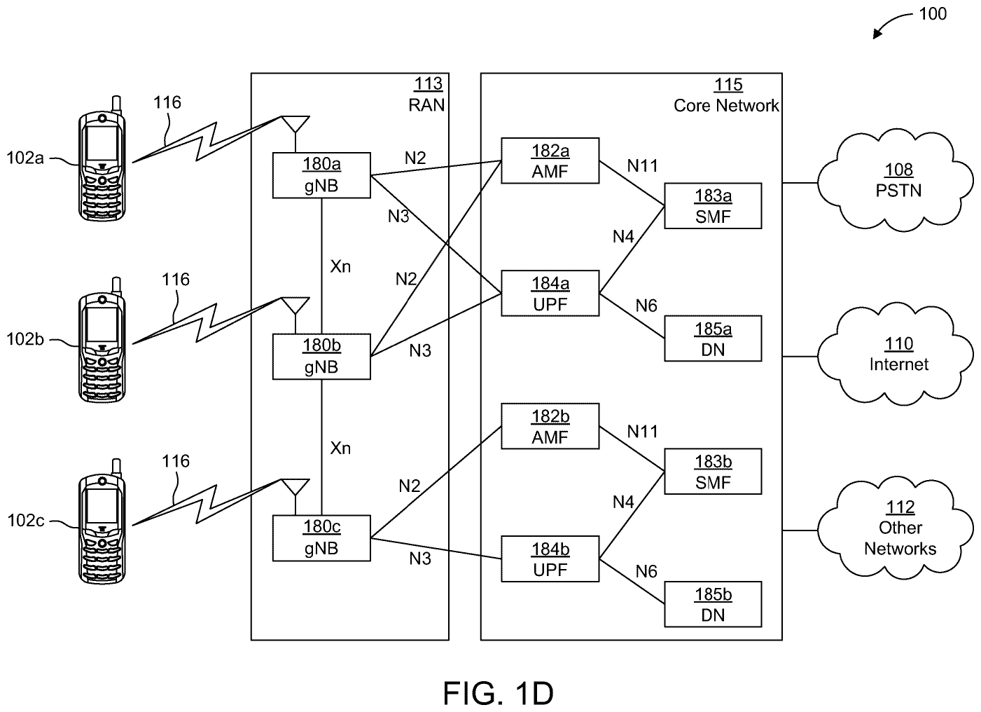

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (and/or a “STA”), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to, for example, facilitate access to one or more communication networks, such as the CN 106, the Internet 110, and/or the other networks 112. By way of example, the base stations 114a, 114b may be a base transceiver station (BTS), a Node B, an eNode-B (eNB), a Home Node-B (HNB), a Home eNode-B (HeNB, a next generation Node-B (NR NB), such as a gNode-B (gNB), a new radio (NR) Node-B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, the gNBs 180a, 180b, 180c may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 megahertz (MHz) wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHz, 80 MHz, and/or 160 MHz wide channels transmitted over a 5 GHz frequency band using OFDMA. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHz, 80 MHz, and/or 160 MHz wide channels capable of transmission over 2.4 GHZ, 5 GHZ, and 6 GHz frequency bands using both OFDMA and multi-user multiple-input multiple-output (MU-MIMO) capabilities. OFDMA subcarrier modulation in HE STAs includes formats such as binary phase shift keying (BPSK), QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHZ and 6 GHZ) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability-UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave-IMMW), energy harvesting based on of WiFi RF signals for facilitating WLAN communications of low-power IoT devices, and the randomization of MAC addresses in WLANs.

For an 80+80 configuration, the data, after channel encoding, is passed through a segment parser that divides it into two streams. The Inverse Discrete Fourier Transformation (IDFT) operation and time-domain processing is done on each stream separately. The streams are then mapped on to the two channels, and the data is transmitted. At the receiver, this mechanism is reversed, and the combined data is sent to the MAC layer.

As noted above, in 802.11 ax, High Efficiency (HE) Wireless STAs may support 20 MHz, 40 MHz, 80 MHz, and/or 160 MHz wide channels capable of transmission over 2.4 GHZ, 5 GHZ, and 6 GHz frequency bands using both OFDMA and MU-MIMO capabilities. OFDMA subcarrier modulation in HE STAs includes formats such as BPSK, QPSK, 16-QAM, 64-QAM, 256-QAM, and 1024-QAM. The evolution of 802.11 to EHT or (802.11be) STAs extend to having 320 MHz wide channels.

Sub 1 GHz modes of operation are supported by 802.11af, and 802.11ah. For these specifications the channel operating bandwidths, and carriers, are reduced relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. A possible use case for 802.11ah is support for Meter Type Control (MTC) devices in a macro coverage area. MTC devices may have limited capabilities including only support for limited bandwidths, but also include a requirement for a very long battery life.

WLAN systems which support multiple channels, and channel widths, such as 802.11n, 802.11ac, 802.11af, 802.11ah, 802.11AX, and 802.11be, include a channel which is designated as the primary channel. The primary channel may, but not necessarily, have a bandwidth equal to the largest common operating bandwidth supported by all STAs in the BSS. The bandwidth of the primary channel is therefore limited by the STA, of all STAs in operating in a BSS, which supports the smallest bandwidth operating mode. In the example of 802.11ah, the primary channel may be 1 MHz wide if there are STAs (e.g., MTC type devices) that only support a 1 MHz mode even if the AP, and other STAs in the BSS, may support a 2 MHz, 4 MHz, 8 MHz, 16 MHz, or other channel bandwidth operating modes. All carrier sensing, and NAV settings, depend on the status of the primary channel; i.e., if the primary channel is busy, for example, due to a STA supporting only a 1 MHz operating mode is transmitting to the AP, then the entire available frequency bands are considered busy even though majority of it stays idle and available.

The IEEE 802.11 Ultra High Reliability (UHR) Study Group was formed explore the possibility to improve reliability, support further reduced low latency traffic, further increase peak throughput, improve power saving capabilities, and improve efficiency of the IEEE 802.11 network over HEW. A distributed-tone resource unit (DRU) may be used in UHR communications.

Current Wi-Fi systems face a challenging problem in the design of an optimal Long Training Field (LTF) to support Distributed Resource Unit (DRU). For instance, an exhaustive search for an optimal DRU-LTF sequence for a DRU in a distribution bandwidth of 20 MHz may require one to search for one or more sequences of length 242 that generates the minimum Peak-to-Average-Power Ratio (PAPR) for all DRU sizes within this distribution bandwidth. Each element of this LTF sequence of size 242 may take the value 1 or the value −1. In an example, the sequence is BPSK modulated. The search space of such a sequence contains 2²⁴²=7.06738826×10⁷² sequences. Assuming each sequence requires 1 ns to compute the PAPR, one could need 10⁵⁷ years or a little bit more to find this optimal sequence. This is longer than the known age of the universe. Accordingly, such a brute force approach is clearly infeasible for practical use in wireless communication.

Embodiments and examples herein address this problem and include the design of an optimal DRU-LTF sequence. This sequence may be used in Wi-Fi but may also be used in other current and future wireless systems.

In embodiments and examples provided herein, a tone may refer to one subcarrier used in DL or UL transmission. A DRU is a resource unit whose subcarriers are spread over a certain bandwidth which is larger than the effective bandwidth occupied by this resource unit. The effective bandwidth of an RU equals N×Δfₛ where N is the number of tones of the RU and Δfₛ is the subcarrier spacing. In WLAN, range extension can be achieved by distributing the tones of an RU over a wider bandwidth which allows for higher transmit power for each individual tone while at the same time conforming with the power spectral density (PSD) regulations.

Further, a DRU may also be referred to as a tone distributed (TD) RU (TD-RU) or a distributed RU, and still be consistent with the embodiments and example provided herein. Also, a distribution bandwidth may refer to a bandwidth in which the tones of a set of one or more DRUs are spread on.

A specific DRU may be expressed as xDRUy and may refer to a DRU of x-tones distributed over a distribution bandwidth of y. For example 26DRU20 may refer to a DRU of 26 tones distributed over a distribution bandwidth of 20 MHz. In an example, a 26DRU20 is a 26-tone resource unit (effective bandwidth is ˜2 MHz) with a DRU allocation spread over a distribution bandwidth of 20 MHz. In another example, a 106DRU80 is a 106-tone resource unit (effective bandwidth is ˜8 MHz) with a DRU allocation spread over a distribution bandwidth of 80 MHz. A 20 MHz channel may include up to nine 26DRU20 DRU allocations, four 52DRU20 DRU allocations, or two 106DRU20 DRU allocations. For proper transmission, a channel bandwidth should accommodate the effective bandwidth of the DRUs as well as bandwidth needed for guard, null and DC subcarriers. Further, a specific DRU with a specific tone distribution pattern z may be expressed as xDRUy_z. For example 26DRU20_1 may refer to a DRU of 26 tones evenly distributed over a distribution bandwidth of 20 MHz with a tone distribution pattern 1.

A PAPR is defined as the peak power within one OFDM symbol normalized by the average signal power, expressed in decibels (dB). In general, a lower PAPR is desired for efficient performance of a system. Thus, an LTF sequence that causes the lowest possible PAPR when transmitted using a DRU is considered an optimal DRU-LTF. In a system which employs a DRU, one would better think of an LTF sequence that is optimal for the DRU size, not for the distribution bandwidth (DBW). Specifically, in a DBW=20 MHz, there could be three different sizes of DRU, namely, 26DRU20, 52DRU20, and 106DRU20. Since these DRUs will only be used in uplink transmission and will be used to transmit packets from individual non-AP STAs, it may make more sense to search for an LTF sequence that is optimal for each size of DRU.

The search strategy for the optimal LTF sequence for a 26DRU20 is based on the exhaustive search of all of the LTF sequences of size 26 (67,108,864 different sequences). By computing the PAPR of all of the LTF sequences of size 26, one could find one or more LTF sequences that are optimal for each DRU of size 26 in DBW=20 for a specific tone plan. Similarly, optimal sequences could be found for 26DRU40 and 26DRU80.

In the search for an optimal LTF sequence for 52DRU20, an exhaustive search would require the search in more than 4500 trillion sequences, which is manifestly not practical. Accordingly, a more practical search strategy is needed even if the found sequence cannot be proven to be optimal. To this end, in the following sections, a more practical search strategy is described for DRUs of sizes larger than 26-tones.

Examples provided herein include the algorithms to find the optimal DRU-LTF sequences.

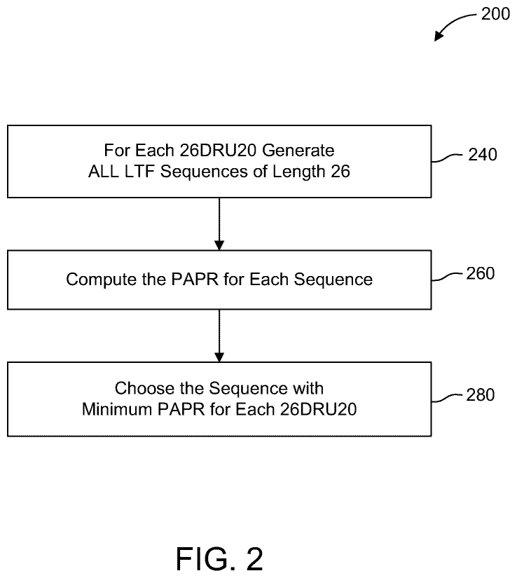

FIG. 2 is a flowchart diagram illustrating determination of the optimal LTF sequences for a 26DRU20. As shown in an example procedure in flowchart diagram 200, for each 26DRU20 in a general tone plan, the procedure generates 240 all possible LTF sequences of length 26. Further, the procedure computes the PAPR for each sequence 260. The procedure then chooses the sequence with the minimum PAPR for each 26DRU20 in the tone plan 280. The procedure may be performed by a server, AP, STA or other entity with processing capability.

In an example, the algorithm to find an optimal LTF sequence for a DRU of size 26DRU20 for a general tone plan TONEPLAN is listed below:

| 1. For each DRU of size 26DRU20 | |
|---|---|
| a. Set PAPRmin = 0 , j = 0, LTFo = { }, PAPRo = { }, | |
| LTF_Optimal = { }, PAPR_Optimal = 0 | |
| b. For i = 1 to 2²⁶ | |
| i. | papr = PAPR(LTF_Sequence26(i), TONEPLAN) |
| ii. | If papr < PAPRmin then |
| | j = j +1 |
| | PAPRmin = papr |
| | LTFo(j) = LTF_Sequence26(i) |
| | PAPRo (j) = PAPRmin |
| iii. | End if |

c. Repeat b
2. PAPR_Optimal = min(PAPRo)
3. LTF_Optimal = LTFo(Index(PAPR_Optimal)
4. Repeat 1

The function PAPR (LTF_Sequence26(i), TONEPLAN_1) returns the PAPR computed for a certain LTF sequence number i of size 26 and a certain tone plan TONEPLAN. Further, the function Index (PAPR_Optimal) returns the indices of the minimum PAPRo value.

The exhaustive search for an optimal LTF sequence for an 52DRU20 has a search space of 4500 trillion sequences. In order to find an optimal LTF sequence (global optimum or local optimum) for the case of 52DRU20, a better approach is to search in parts of the search space that have special properties. Accordingly, the procedure may search on two components of the 52DRU20, a first 26DRU20 component and a second 26DRU20 component, as detailed further in the following. Further, for a 106DRU20, the procedure may search on four components of the 106DRU20, a first 26DRU20 component, a second 26DRU20 component, a third 26DRU20 component, and a fourth 26DRU20 component, as detailed further in the following. Specific components for different DRUs are provided in Tables 3 through 44.

In an example illustrated in the third row of Table 1, below, the search for the optimal LTF sequence for 52DRU20 may be performed by reusing the LTF sequence values which are optimal for the first 26DRU20, or 26DRU20 #1. Further, the STA performs an exhaustive search in all sequences of length 26 which may be assigned to the tones of the second 26DRU20, or 26DRU20 #2, to find the LTF sequence of length 52 which has the smallest PAPR value for the combined sequence. As a result, by splitting the search for 52DRU20 into two 26DRU20 components or parts, the optimal sequence for the 52DRU20 may be found more efficiently than a brute force method.

In another example, as illustrated in the fourth row of Table 1, the search for the optimal LTF sequence for 52DRU20 may be performed by reusing the LTF sequence values which are optimal for the 26DRU20 #2, and perform an exhaustive search in all sequences of length 26 which may be assigned to the tones of 26DRU20 #1 to find the LTF sequence of length 52 which has the smallest PAPR value for the combined sequence. As shown below in an example in Table 4, the LTF sequence that is optimal for 26DRU20 #1 is [LTF26DRU20_1] and the LTF sequence that is optimal for 26DRU20 #2 is [LTF26DRU20_1].

TABLE 1
Search algorithm for 52DRU20
52DRU20#1
[LTF52DRU20_1]

| | |
|---|---|
| 26DRU20 #1 | 26DRU20 #2 |
| [LTF26DRU20_1] | ? |
| ? | [LTF26DRU20_1] |

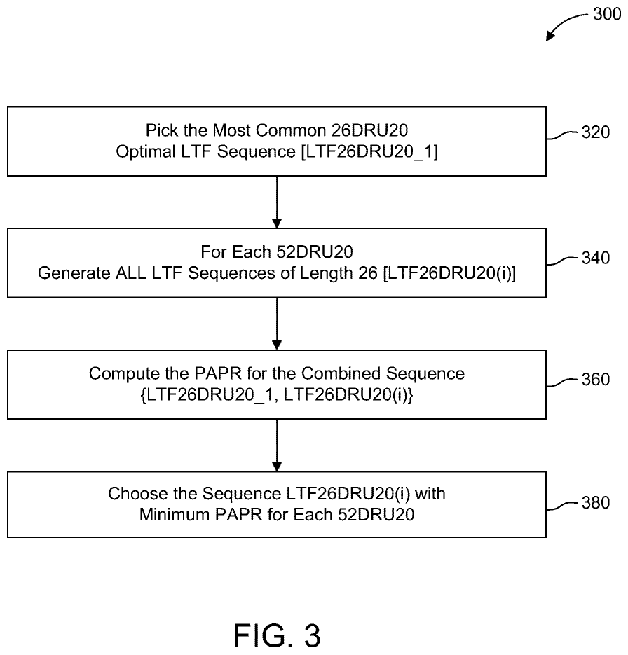

FIG. 3 is a flowchart diagram illustrating determination of the optimal LTF sequences for a 52DRU20. As shown in an example procedure in flowchart diagram 300, the procedure picks the most common 26DRU20 optimal LTF sequence in a general tone plan 320. In an example, the most common 26DRU20 optimal LTF sequence may be described as LTF26DRU20_1. Further, for each 52DRU20 in the general tone plan, the procedure generates 340 all LTF sequences of length 26, each of which may be represented as LTF26DRU20(i) in the algorithm. Also, the procedure computes 360 the PAPR for the combined sequence LTF26DRU20_1, LTF26DRU20(i). Moreover, the procedure chooses 380 the sequence LTF26DRU20 with the minimum PAPR out of all of the sequences of length 26 for each 52DRU20.

Accordingly, the procedure determines a DRU LTF is the optimal LTF for the most tone distribution patterns in a tone plan. For tone plan 1, with a distribution bandwidth of 20 MHz, the optimal LTF for the most tone distribution patterns is LTF26DRU20_1.

Examples provided herein provide the optimal LTF sequences for DRUs using tone plan 1, with a distribution bandwidth of 20 MHz. For example, the optimal LTF sequences for 26DRU20 for an exemplary tone plan 1, shown in Table 2, below, is listed in Table 3, further below. Also, the mapping of the optimal sequences to the nine 26DRU20 tone distribution patterns is listed in Table 4, further below. In the tables listed below, a DRU followed by a number is considered to be a DRU for the numbered tone distribution plan in that tone plan. For example, DRU1 in the first row of Table 2 is 26DRU20_1 for tone plan 1, and DRU2 in the fifth row of Table 2 is 106DRU20_2 for tone plan 1.

TABLE 2
Tone Plan 1 (DBW = 20 MHz)

| 26-tone DRU | DRU1 | DRU2 | DRU3 | DRU4 | DRU5 |
|---|---|---|---|---|---|
| | (26DRU20_1) | [−116:9:−8, | [−118:9:−10, | [−114:9:−6, | [−112:9:−4, |
| | [−120:9:−12, | 10:9:118] | 8:9:116] | 12:9:120] | 5:9:113] |
| | 6:9:114] | | | | |
| | DRU6 | DRU7 | DRU8 | DRU9 | |
| | [−119:9:−11, | [−115:9:−7, | [−117:9:−9, | [−113:9:−5, | |
| | 7:9:115] | 11:9:119] | 9:9:117] | 4:9:112] | |

| | | |
|---|---|---|
| 52-tone DRU | DRU1 | DRU2 |
| | 26-tone [DRU1, DRU2] | 26-tone [DRU3, DRU4] |
| | DRU3 | DRU4 |
| | 26-tone [DRU6, DRU7] | 26-tone [DRU8, DRU9] |
| 106-tone DRU | DRU1 | DRU2 (106DRU20_2) |
| | 26-tone [DRU1~4], [−3, 3] | 26-tone [DRU6~9], [−2, 2] |

TABLE 3
Exemplary Optimal DRU LTF Sequences
for 26DRU20 (Tone Plan 1)

| Optimal | |
|---|---|
| Sequence | |
| Number | Optimal LTF Sequence |
| LTF26DRU20_1 | −1, −1, −1, 1, 1, 1, −1, −1, −1, 1, −1, −1, −1, |
| | 1, −1, 1, 1, 1, −1, 1, 1, −1, 1, 1, −1, 1 |
| LTF26DRU20_2 | −1, −1, 1, 1, −1, −1, −1, 1, 1, −1, 1, 1, 1, 1, |
| | 1, 1, −1, −1, 1, −1, 1, 1, 1, −1, 1, −1 |
| LTF26DRU20_3 | −1, 1, −1, −1, 1, −1, −1, 1, −1, −1, −1, 1, −1, |
| | 1, 1, 1, −1, 1, 1, 1, −1, −1, −1, 1, 1, 1 |

TABLE 4
Exemplary Optimal DRU LTF Sequence Mapping
for 26DRU20 for (Tone Plan 1)

| 26DRU20 | Optimal LTF Sequence (Tone Plan 1) |
|---|---|
| 1 (26DRU20_1) | LTF26DRU20_1 |
| 2 | LTF26DRU20_1 |
| 3 | LTF26DRU20_1 |
| 4 | LTF26DRU20_1 |
| 5 | LTF26DRU20_2 |
| 6 | LTF26DRU20_1 |
| 7 | LTF26DRU20_1 |
| 8 | LTF26DRU20_3 |
| 9 (26DRU20_9) | LTF26DRU20_2 |

In another example, the optimal LTF sequences for 52DRU20 may be constructed by combining the most common optimal sequence for 26DRU20, namely, LTF26DRU20_1 (such as from Table 3) as a first component with the optimal sequences in Table 5, below, as a second component. The LTF26DRU20_1, with sequence −1, −1, −1, 1, 1, 1, −1, −1, −1, 1, −1, −1, −1, 1, −1, 1, 1, 1, −1, 1, 1, −1, 1, 1, −1, 1, is listed first in Table 3, above, because it is the most commonly used optimal LTF sequence for 26DRU20s in the tone plan.

TABLE 5
Exemplary Optimal DRU Component LTF
Sequences for 52DRU20 for Tone Plan

| Optimal | |
|---|---|
| Sequence | |
| Number | Optimal LTF Sequence |
| LTF26DRU20_4 | 1, −1, 1, −1, −1, 1, −1, 1, 1, −1, 1, 1, 1, −1, |
| | 1, 1, 1, 1, −1, 1, −1, −1, −1, 1, −1, −1 |
| LTF26DRU20_5 | −1, −1, −1, 1, −1, 1, 1, 1, −1, −1, 1, 1, −1, −1, |
| | 1, −1, 1, −1, −1, 1, −1, −1, −1, −1, −1, 1 |

In an example, the optimal LTF sequences for 52DRU20 considering an exemplary tone plan 1 (such as from Table 2) is listed in Table 6, below, and the mapping of the optimal sequences to the four 52DRU20s is listed in Table 7, further below.

TABLE 6
Exemplary Optimal DRU LTF Sequences
for 52DRU20 for Tone Plan 1

| Optimal Sequence | |
|---|---|
| Number | Optimal LTF Sequence |
| LTF52DRU20_1 | {LTF26DRU20_1, LTF26DRU20_4} |
| LTF52DRU20_2 | {LTF26DRU20_1, LTF26DRU20_5} |

TABLE 7
Exemplary Optimal DRU LTF Sequence
Mapping for 52DRU20 for Tone Plan 1

| 52DRU20 | Tone Plan 1 |
|---|---|
| 1 (52DRU20_1) | LTF52DRU20_1 |
| 2 | LTF52DRU20_1 |
| 3 | LTF52DRU20_1 |
| 4 (52DRU20_4) | LTF52DRU20_2 |

In another embodiment, the optimal LTF sequences for 106DRU20 may be constructed by combining sequences from Tables provided herein (such as Table 3, Table 5, and Table 8 (below) as listed in Table 10, below.

TABLE 8
Exemplary Optimal DRU Component LTF Sequences
for 106DRU20 for Tone Plan 1

| Optimal | |
|---|---|
| Sequence | |
| Number | Optimal LTF Sequence |
| LTF26DRU20_6 | −1, 1, −1, −1, 1, 1, −1, −1, −1, −1, 1, −1, −1, |
| | 1, 1, 1, −1, 1, −1, 1, 1, −1, −1, −1, 1, −1 |
| LTF26DRU20_7 | −1, 1, −1, 1, 1, 1, 1, −1, −1, −1, −1, −1, 1, |
| | 1, 1, 1, −1, −1, 1, 1, −1, 1, −1, 1, −1, 1 |
| LTF26DRU20_8 | −1, −1, 1, 1, 1, −1, 1, −1, −1, 1, 1, 1, |
| | 1, −1, −1, −1, −1, 1, −1, −1, −1, −1, 1, −1, 1, −1 |

In a further example, the optimal LTF sequences for 106DRU20 considering an exemplary tone plan 1 (such as from Table 2) is listed in Table 9, below, and the mapping of the optimal sequences to the two 106DRU20s is listed in Table 10, further below.

TABLE 9
Exemplary Optimal DRU LTF Sequences
for 106DRU20 for Tone Plan 1

| Optimal | |
|---|---|
| Sequence | |
| Number | Optimal LTF Sequence |
| LTF106DRU20_1 | {LTF26DRU20_1, LTF26DRU20_5, |
| | LTF26DRU20_6, LTF26DRU20_7}, {1, −1} |
| LTF106DRU20_2 | {LTF26DRU20_1, LTF26DRU20_5, |
| | LTF26DRU20_6, LTF26DRU20_8}, {−1, −1} |

TABLE 10
Exemplary Optimal DRU LTF Sequence Mapping
for 106DRU20 for Tone Plan 1

| 106DRU20 | Tone Plan 1 |
|---|---|
| 106DRU20_1 | LTF106DRU20_1 |
| 106DRU20_2 | LTF106DRU20_2 |

Examples provided herein provide the optimal LTF sequences for DRUs using tone plan 2, with a distribution bandwidth of 20 MHz. For example, the optimal LTF sequences for 26DRU20 considering an exemplary tone plan 2 (such as from Table 11, below) is listed in Table 12, further below, and the mapping of the optimal sequences to the nine 26DRU20s is listed in Table 13, further below.

TABLE 11
Tone Plan 2

| 26-tone DRU | DRU1 | DRU2 | DRU3 | DRU4 | DRU5 |
|---|---|---|---|---|---|
| | (26DRU20_1) | [−115:9:−7, | [−118:9:−10, | [−113:9:−5, | [−117:9:−9, |
| | [−120:9:−12, | 11:9:119] | 8:9:116] | 4:9:112] | 9:9:117] |
| | 6:9:114] | | | | |
| | DRU6 | DRU7 | DRU8 | DRU9 | |
| | [−112:9:−4, | [−116:9:−8, | [−119:9:−11, | [−114:9:−6, | |
| | 5:9:113] | 10:9:118] | 7:9:115] | 12:9:120] | |

| | | |
|---|---|---|
| 52-tone DRU | DRU1 | DRU2 |
| | 26-tone [DRU1, DRU2] | 26-tone [DRU3, DRU4] |
| | DRU3 | DRU4 |
| | 26-tone [DRU6, DRU7] | 26-tone [DRU8, DRU9] |
| 106-tone DRU | DRU1 | DRU2 |
| | 26-tone [DRU1~4], [−3, 2] | (106DRU20_2) |
| | | 26-tone [DRU6~9], [−2, 3] |

TABLE 12
Exemplary Optimal DRU LTF Sequences
for 26DRU20 (Tone Plan 2)

| Optimal | |
|---|---|
| Sequence | |
| Number | Optimal LTF Sequence |
| LTF26DRU20_1 | −1, −1, −1, 1, 1, 1, −1, −1, −1, 1, −1, −1, −1, |
| | 1, −1, 1, 1, 1, −1, 1, 1, −1, 1, 1, −1, 1 |
| LTF26DRU20_2 | −1, −1, 1, 1, −1, −1, −1, 1, 1, −1, 1, 1, 1, 1, |
| | 1, 1, −1, −1, 1, −1, 1, 1, 1, −1, 1, −1 |
| LTF26DRU20_3 | −1, 1, −1, −1, 1, −1, −1, 1, −1, −1, −1, 1, −1, |
| | 1, 1, 1, −1, 1, 1, 1, −1, −1, −1, 1, 1, 1 |

TABLE 13
Exemplary Optimal DRU LTF Sequence Mapping
for 26DRU20 for (Tone Plan 2)

| 26DRU20 | Optimal LTF Sequence (Tone Plan 1) |
|---|---|
| 1 (26DRU20_1) | LTF26DRU20_1 |
| 2 | LTF26DRU20_1 |
| 3 | LTF26DRU20_1 |
| 4 | LTF26DRU20_2 |
| 5 | LTF26DRU20_3 |
| 6 | LTF26DRU20_2 |
| 7 | LTF26DRU20_1 |
| 8 | LTF26DRU20_1 |
| 9 (26DRU20_9) | LTF26DRU20_1 |

In another example, the optimal LTF sequences for 52DRU20 may be constructed by combining the most common optimal sequence for 26DRU20, namely, LTF26DRU20_1 (such as in Table 12) with the optimal sequences in Table 14, below.

TABLE 14
Exemplary Optimal DRU Component LTF
Sequences for 52DRU20 for Tone Plan 2

| Optimal | |
|---|---|
| Sequence | |
| Number | Optimal LTF Sequence |
| LTF26DRU20_4 | 1, −1, 1, −1, −1, 1, −1, 1, 1, −1, 1, 1, 1, −1, |
| | 1, 1, 1, 1, −1, 1, −1, −1, −1, 1, −1, −1 |
| LTF26DRU20_5 | −1, 1, −1, −1, −1, 1, 1, 1, 1, −1, 1, −1, 1, |
| | 1, −1, 1, 1, 1, −1, 1, 1, 1, −1, −1, 1, −1 |
| LTF26DRU20_6 | −1, −1, −1, 1, −1, 1, 1, 1, −1, −1, 1, 1, −1, −1, |
| | 1, −1, 1, −1, −1, 1, −1, −1, −1, −1, −1, 1 |

In an example, the optimal LTF sequences for 52DRU20 considering an exemplary tone plan 2 (such as in Table 11) is listed in Table 15, below, and the mapping of the optimal sequences to the four 52DRU20s is listed in Table 16, further below.

TABLE 15
Exemplary Optimal DRU LTF Sequences
for 52DRU20 for Tone Plan 2

| Optimal Sequence | |
|---|---|
| Number | Optimal LTF Sequence |
| LTF52DRU20_1 | {LTF26DRU20_1, LTF26DRU20_4} |
| LTF52DRU20_2 | {LTF26DRU20_1, LTF26DRU20_5} |
| LTF52DRU20_3 | {LTF26DRU20_1, LTF26DRU20_6} |

TABLE 16
Exemplary Optimal DRU LTF Sequence
Mapping for 52DRU20 for Tone Plan 2

| 52DRU20 | Tone Plan 2 |
|---|---|
| 1 (52DRU20_1) | LTF52DRU20_1 |
| 2 | LTF52DRU20_2 |
| 3 | LTF52DRU20_3 |
| 4 (52DRU20_4) | LTF52DRU20_1 |

In another example, the optimal LTF sequences for 106DRU20 may be constructed by combining sequences from Tables (such as Table 12, Table 14, and Table 17 (below) as listed in Table 18, further below.

TABLE 17
Exemplary Optimal DRU Component LTF Sequences
for 106DRU20 for Tone Plan 2

| Optimal | |
|---|---|
| Sequence | |
| Number | Optimal LTF Sequence |
| LTF26DRU20_7 | 1, −1, 1, −1, 1, 1, 1, −1, −1, −1, −1, −1, −1, |
| | 1, 1, 1, 1, 1, 1, 1, 1, −1, 1, 1, 1, −1 |
| LTF26DRU20_8 | 1, 1, 1, −1, 1, −1, 1, 1, −1, 1, −1, 1, −1, 1, |
| | 1, −1, −1, 1, 1, 1, 1, −1, 1, −1, −1, −1 |
| LTF26DRU20_9 | 1, 1, 1, 1, 1, 1, −1, −1, −1, 1, −1, −1, −1, 1, |
| | 1, −1, 1, 1, −1, 1, −1, 1, 1, 1, 1, −1 |

TABLE 18
Exemplary Optimal DRU LTF Sequences
for 106DRU20 for Tone Plan 2

| Optimal | |
|---|---|
| Sequence | |
| Number | Optimal LTF Sequence |
| LTF106DRU20_1 | {LTF26DRU20_1, LTF26DRU20_4, |
| | LTF26DRU20_7, LTF26DRU20_8}, |
| | {1, 1} |
| LTF106DRU20_2 | {LTF26DRU20_1, LTF26DRU20_4, |
| | LTF26DRU20_7, LTF26DRU20_9}, |
| | {−1, −1} |

In an example, the optimal LTF sequences for 106DRU20 considering an exemplary tone plan 2 (such as in Table 11) as listed in Table 18, and the mapping of the optimal sequences to the two 106DRU20s is listed in Table 19, below.

TABLE 19
Exemplary Optimal DRU LTF Sequence Mapping
for 106DRU20 for Tone Plan 2

| 106DRU20 | Tone Plan 2 |
|---|---|
| 106DRU20_1 | LTF106DRU20_1 |
| 106DRU20_2 | LTF106DRU20_2 |

Examples provided herein provide the optimal LTF sequences for DRUs using tone plan 3, with a distribution bandwidth of 40 MHz. In an example, the optimal LTF sequences for 26DRU40 considering an exemplary tone plan 3 (such as in Table 20 (below)), is listed in Table 21, further below, and the mapping of the optimal sequences to the eighteen 26DRU40s is listed in Table 22.

TABLE 20
Tone Plan 3

| 26-tone DRU | DRU1 | DRU2 | DRU3 | DRU4 | DRU5 |
|---|---|---|---|---|---|
| | (26DRU40_1) | [−233:18:−17, | [−238:18:−22, | [−229:18:−13, | [−225:18:−9, |
| | [−242:18:−26, | 19:18:235] | 14:18:230] | 23:18:239] | 27:18:243] |
| | 10:18:226] | | | | |
| | DRU6 | DRU7 | DRU8 | DRU9 | DRU10 |
| | [−240:18:−24, | [−231:18:−15, | [−236:18:−20, | [−227:18:−11, | [−241:18:−25, |
| | 12:18:228] | 21:18:237] | 16:18:232] | 25:18:241] | 11:18:227] |
| | DRU11 | DRU12 | DRU13 | DRU14 | DRU15 |
| | [−232:18:−16, | [−237:18:−21, | [−228:18:−12, | [−234:18:−18, | [−239:18:−23, |
| | 20:18:236] | 15:18:231] | 24:18:240] | 18:18:234] | 13:18:229] |
| | DRU16 | DRU17 | DRU18 | | |
| | [−230:18:−14, | [−235:18:−19, | [−226:18:−10, | | |
| | 22:18:238] | 17:18:233] | 26:18:242] | | |
| 52-tone DRU | DRU1 | DRU2 | DRU3 | DRU4 | DRU5 |
| | [−242:9:−17, | [−238:9:−13, | [−240:9:−15, | [−236:9:−11, | [−241:9:−16, |
| | 10:9:235] | 14:9:239] | 12:9:237] | 16:9:241] | 11:9:236] |
| | DRU6 | DRU7 | DRU8 | | |
| | [−237:9:−12, | [−239:9:−14, | [−235:9:−10, | | |
| | 15:9:240] | 13:9:238] | 17:9:242] | | |
| 106-tone DRU | DRU1 | DRU2 | DRU3 | DRU4 (106DRU40_4) | |
| | 26-tone | 26-tone | 26-tone | 26-tone | |
| | [DRU1~4], | [DRU6~9], | [DRU10~13], | [DRU15~18], | |
| | [−8, 5] | [−6, 7] | [−7, 6] | [−5, 8] | |

TABLE 21
Exemplary Optimal DRU LTF Sequences
for 26DRU40 (Tone Plan 3)

| Optimal | |
|---|---|
| Sequence Number | Optimal LTF Sequence |
| LTF26DRU40_1 | −1, −1, −1, 1, 1, 1, −1, −1, −1, 1, −1, −1, −1, |
| | 1, −1, 1, 1, 1, −1, 1, 1, −1, 1, 1, −1, 1 |
| LTF26DRU40_2 | −1, 1, −1, −1, 1, −1, −1, 1, −1, −1, −1, 1, −1, |
| | 1, 1, 1, −1, 1, 1, 1, −1, −1, −1, 1, 1, 1 |

TABLE 22
Exemplary Optimal DRU LTF Sequence Mapping
for 26DRU40 for (Tone Plan 3)

| | Optimal LTF Sequence |
|---|---|
| 26DRU40 | (Tone Plan 3) |
| 1 (26DRU40_1) | LTF26DRU40_1 |
| 2 | LTF26DRU40_1 |
| 3 | LTF26DRU40_2 |
| 4 | LTF26DRU40_2 |
| 5 | LTF26DRU40_1 |
| 6 | LTF26DRU40_2 |
| 7 | LTF26DRU40_1 |
| 8 | LTF26DRU40_1 |
| 9 | LTF26DRU40_1 |
| 10 | LTF26DRU40_1 |
| 11 | LTF26DRU40_1 |
| 12 | LTF26DRU40_1 |
| 13 | LTF26DRU40_1 |
| 14 | LTF26DRU40_1 |
| 15 | LTF26DRU40_1 |
| 16 | LTF26DRU40_1 |
| 17 | LTF26DRU40_1 |
| 18 (26DRU40_18) | LTF26DRU40_1 |

In another example, the optimal LTF sequences for 52DRU40 may be constructed by combining the most common optimal sequence for 26DRU40, namely, LTF26DRU40_1 (such as in Table 21 (above)) with the optimal sequences in Table 23, as follows.

TABLE 23
Exemplary Optimal DRU Component LTF
Sequences for 52DRU40 for Tone Plan 3

| Optimal | |
|---|---|
| Sequence | |
| Number | Optimal LTF Sequence |
| LTF26DRU40_3 | −1, −1, 1, −1, 1, −1, 1, −1, −1, −1, −1, |
| | 1, −1, −1, −1, −1, −1, 1, −1, 1, 1, −1, 1, −1, −1, −1 |

In an example, the optimal LTF sequences for 52DRU40 considering an exemplary tone plan 3 (such as in Table 20 (above) is listed in Table 24, below, and the mapping of the optimal sequences to the eight 52DRU40s is listed in Table 25, further below.

TABLE 24
Exemplary Optimal DRU LTF Sequences
for 52DRU40 for Tone Plan 3

| Optimal Sequence | |
|---|---|
| Number | Optimal LTF Sequence (Tone Plan 3) |
| LTF52DRU40_1 | {LTF26DRU40_1, LTF26DRU40_3} |

TABLE 25
Exemplary Optimal DRU LTF Sequence
Mapping for 52DRU40 for Tone Plan 3

| 52DRU40 | Optimal LTF Sequence (Tone Plan 3) |
|---|---|
| 1 (52DRU40_1) | LTF52DRU40_1 |
| 2 | LTF52DRU40_1 |
| 3 | LTF52DRU40_1 |
| 4 | LTF52DRU40_1 |
| 5 | LTF52DRU40_1 |
| 6 | LTF52DRU40_1 |
| 7 | LTF52DRU40_1 |
| 8 (52DRU40_8) | LTF52DRU40_1 |

In another example, optimal LTF sequences for 106DRU40 may be constructed by combining sequences from Tables (such as Table 21 (above), Table 23 (above), and Table 26 (below) as listed in Table 27, below.

In an example, the optimal LTF sequences for 106DRU40 considering an exemplary tone plan 3 (such as in Table 20 (above) is listed in Table 27, below, and the mapping of the optimal sequences to the two 106DRU40s is listed in Table 28, further below.

TABLE 26
Exemplary Optimal DRU Component LTF Sequences
for 106DRU40 for Tone Plan 3

| Optimal | |
|---|---|
| Sequence | |
| Number | Optimal LTF Sequence |
| LTF26DRU40_4 | 1, −1, 1, −1, 1, 1, 1, 1, 1, −1, 1, 1, −1, −1, |
| | 1, −1, 1, −1, 1, −1, 1, 1, −1, 1, 1, 1 |
| LTF26DRU40_5 | 1, 1, −1, 1, −1, −1, 1, −1, −1, −1, −1, −1, −1, −1, |
| | 1, 1, −1, 1, 1, −1, −1, −1, 1, −1, −1, 1 |

TABLE 27
Exemplary Optimal DRU LTF Sequences
for 106DRU40 for Tone Plan 3

| Optimal Sequence | |
|---|---|
| Number | Optimal LTF Sequence |
| LTF106DRU40_1 | {LTF26DRU40_1, LTF26DRU40_3, |
| | LTF26DRU40_4, LTF26DRU40_5}, {1, −1} |

TABLE 28
Exemplary Optimal DRU LTF Sequences
Mapping for 106DRU40 for Tone Plan 3

| 106DRU40 | Tone Plan 3 |
|---|---|
| 1 (106DRU40_1) | LTF106DRU40_1 |
| 2 | LTF106DRU40_1 |
| 3 | LTF106DRU40_1 |
| 4 (106DRU40_4) | LTF106DRU40_1 |

Examples provided herein provide the optimal LTF sequences for DRUs using tone plan 4, with a distribution bandwidth of 80 MHz. In an example, the optimal LTF sequences for 52DRU80 considering an exemplary tone plan 4 (such as in Table 29 (below) is listed in Table 32, further below, and the mapping of the optimal sequences to the sixteen 52DRU80s is listed in Table 33, further below.

TABLE 29
Tone Plan 4

| 52-tone DRU | DRU1 (52DRU80_1) | DRU2 | DRU3 | DRU4 |
|---|---|---|---|---|
| | [−483:36:−51, | [−475:36:−43, | [−479:36:−47, | [−471:36:−39, |
| | 17:36:449], | 25:36:457], | 21:36:453], | 29:36:461], |
| | [−467:36:−35, | [−459:36:−27, | [−463:36:−31, | [−455:36:−23, |
| | 33:36:465] | 41:36:473] | 37:36:469] | 45:36:477] |
| | DRU5 | DRU6 | DRU7 | DRU8 |
| | [−477:36:−45, | [−469:36:−37, | [−481:36:−49, | [−473:36:−41, |
| | 23:36:455], | 31:36:463], | 19:36:451], | 27:36:459], |
| | [−461:36:−29, | [−453:36:−21, | [−465:36:−33, | [−457:36:−25, |
| | 39:36:471] | 47:36:479] | 35:36:467] | 43:36:475] |
| | DRU9 | DRU10 | DRU11 | DRU12 |
| | [−482:36:−50, | [−474:36:−42, | [−478:36:−46, | [−470:36:−38, |
| | 18:36:450], | 26:36:458], | 22:36:454], | 30:36:462], |
| | [−466:36:−34, | [−458:36:−26, | [−462:36:−30, | [−454:36:−22, |
| | 34:36:466] | 42:36:474] | 38:36:470] | 46:36:478] |
| | DRU13 | DRU14 | DRU15 | DRU16 |
| | [−476:36:−44, | [−468:36:−36, | [−480:36:−48, | [−472:36:−40, |
| | 24:36:456], | 32:36:464], | 20:36:452], | 28:36:460], |
| | [−460:36:−28, | [−452:36:−20, | [−464:36:−32, | [−456:36:−24, |
| | 40:36:472] | 48:36:480] | 36:36:468] | 44:36:476] |
| 106-tone DRU | DRU1 | DRU2 | DRU3 | DRU4 |
| | 52-tone | 52-tone | 52-tone | 52-tone |
| | [DRU1~2], | [DRU3~4], | [DRU5~6], | [DRU7~8], |
| | [−495, 485] | [−491, 489] | [−489, 491] | [−493, 487] |
| | DRU5 | DRU6 | DRU7 | DRU8 |
| | 52-tone | 52-tone | 52-tone | (106DRU80_8) 52-tone |
| | [DRU9~10], | [DRU11~12], | [DRU13~14], | [DRU15~16], |
| | [−494, 486] | [−490, 490] | [−488, 492] | [−492, 488] |

In another example, the optimal LTF sequences for 52DRU80 may be constructed by combining the most common optimal sequence for 26DRU80, namely, LTF26DRU80_1 (such as in Table 30 (below), with the optimal sequences in Table 31.

TABLE 30
Exemplary Optimal DRU LTF Sequences
for 26DRU80 (Tone Plan 4)

| Optimal | |
|---|---|
| Sequence Number | Optimal LTF Sequence |
| LTF26DRU80_1 | −1, −1, −1, 1, −1, 1, 1, 1, −1, 1, −1, −1, 1, −1, |
| | 1, −1, −1, −1, −1, 1, −1, −1, −1, −1, 1, 1 |
| LTF26DRU80_2 | −1, −1, 1, 1, 1, 1, −1, 1, 1, 1, 1, −1, 1, −1, 1, 1, −1, |
| | 1, −1, −1, −1, 1, −1, 1, 1, 1 |

TABLE 31
Exemplary Optimal DRU Component LTF
Sequences for 52DRU80 for Tone Plan 4

| Optimal | |
|---|---|
| Sequence Number | Optimal LTF Sequence |
| LTF26DRU80_3 | −1, −1, 1, 1, −1, −1, 1, −1, 1, −1, −1, −1, −1, −1, |
| | 1, −1, 1, 1, 1, −1, −1, 1, 1, −1, −1, 1 |

TABLE 32
Exemplary Optimal DRU LTF Sequences
for 52DRU80 for Tone Plan 4

| Optimal Sequence Number | Optimal LTF Sequence (Tone Plan 4) |
|---|---|
| LTF52DRU80_1 | {LTF26DRU80_1, LTF26DRU80_3} |

TABLE 33
Exemplary Optimal DRU LTF Sequence
Mapping for 52DRU80 for Tone Plan 4

| 52DRU80 | Optimal LTF Sequence (Tone Plan 4) |
|---|---|
| 1 (52DRU80_1) | LTF52DRU80_1 |
| 2 | LTF52DRU80_1 |
| 3 | LTF52DRU80_1 |
| 4 | LTF52DRU80_1 |
| 5 | LTF52DRU80_1 |
| 6 | LTF52DRU80_1 |
| 7 | LTF52DRU80_1 |
| 8 | LTF52DRU80_1 |
| 9 | LTF52DRU80_1 |
| 10 | LTF52DRU80_1 |
| 11 | LTF52DRU80_1 |
| 12 | LTF52DRU80_1 |
| 13 | LTF52DRU80_1 |
| 14 | LTF52DRU80_1 |
| 15 | LTF52DRU80_1 |
| 16 (52DRU80_16) | LTF52DRU80_1 |

In another example, the optimal LTF sequences for 106DRU80 may be constructed by combining sequences from Tables (such as Table 30 (above), Table 31 (above), and Table 34 (below) as listed in Table 35, further below.

TABLE 34
Exemplary Optimal DRU Component LTF Sequences
for 106DRU80 for Tone Plan 4

| Optimal | |
|---|---|
| Sequence Number | Optimal LTF Sequence |
| LTF26DRU80_4 | 1, 1, 1, 1, 1, 1, −1, 1, 1, 1, −1, −1, 1, −1, −1, −1, |
| | 1, −1, 1, 1, 1, −1, −1, −1, −1, −1 |
| LTF26DRU80_5 | 1, −1, 1, 1, −1, 1, −1, 1, 1, −1, 1, −1, −1, 1, |
| | 1, −1, −1, −1, −1, 1, 1, −1, 1, −1, 1, −1 |

TABLE 35
Exemplary Optimal DRU LTF Sequences
for 106DRU80 for Tone Plan 4

| Optimal | |
|---|---|
| Sequence Number | Optimal LTF Sequence |
| LTF106DRU80_1 | {LTF26DRU80_1, LTF26DRU80_3, |
| | LTF26DRU80_4, LTF26DRU80_5}, {1, 1} |

In an example, the optimal LTF sequences for 106DRU80 considering an exemplary tone plan 4 (such as in Table 29 (above) is listed in Table 35, above, and the mapping of the optimal sequences to the eight 106DRU80s is listed in Table 36, below.

TABLE 36
Exemplary Optimal DRU LTF Sequence Mapping
for 106DRU80 for Tone Plan 4

| 106DRU80 | Tone Plan 4 |
|---|---|
| 1 (106DRU80_1) | LTF106DRU80_1 |
| 2 | LTF106DRU80_1 |
| 3 | LTF106DRU80_1 |
| 4 | LTF106DRU80_1 |
| 5 | LTF106DRU80_1 |
| 6 | LTF106DRU80_1 |
| 7 | LTF106DRU80_1 |
| 8 (106DRU80_8) | LTF106DRU80_1 |

Examples provided herein provide the optimal LTF sequences for DRUs using tone plan 5, with a distribution bandwidth of 80 MHz. In an example, the optimal LTF sequences for 52DRU80 considering an exemplary tone plan 5 (such as in Table 37 (below)) is listed in Table 40, further below, and the mapping of the optimal sequences to the sixteen 52DRU80s is listed in Table 41, further below.

TABLE 37
Tone Plan 5

| 52-tone | DRU1 (52DRU80_1) | DRU2 | DRU3 | DRU4 |
|---|---|---|---|---|
| DRU | [−495:56:−271, | [−487:56:−263, | [−491:56:−267, | [−483:56:−259, |
| | −479:56:−255, | −471:56:−247, | −475:56:−251, | −467:56:−243, |
| | −455:56:−287, | −447:56:−279, | −451:56:−283, | −443:56:−275, |
| | −239:56:−71, | −231:56:−63, | −235:56:−67, | −227:56:−59, |
| | −215:56:−47, | −207:56:−39, | −211:56:−43, | −203:56:−35, |
| | −199:56:−31, | −191:56:−23, | −195:56:−27, | −187:56:−19, |
| | 17:56:241, | 25:56:249, | 21:56:245, | 29:56:253, |
| | 33:56:257, | 41:56:265, | 37:56:261, | 45:56:269, |
| | 57:56:225, | 65:56:233, | 61:56:229, | 69:56:237, |
| | 273:56:441, | 281:56:449, | 277:56:445, | 285:56:453, |
| | 297:56:465, | 305:56:473, | 301:56:469, | 309:56:477, |
| | 313:56:481] | 321:56:489] | 317:56:485] | 325:56:493] |
| | DRU5 | DRU6 | DRU7 | DRU8 |
| | [−489:56:−265, | [−481:56:−257, | [−493:56:−269, | [−485:56:−261, |
| | −473:56:−249, | −465:56:−241, | −477:56:−253, | −469:56:−245, |
| | −449:56:−281, | −441:56:−273, | −453:56:−285, | −445:56:−277, |
| | −233:56:−65, | −225:56:−57, | −237:56:−69, | −229:56:−61, |
| | −209:56:−41, | −201:56:−33, | −213:56:−45, | −205:56:−37, |
| | −193:56:−25, | −185:56:−17, | −197:56:−29, | −189:56:−21, |
| | 23:56:247, | 31:56:255, | 19:56:243, | 27:56:251, |
| | 39:56:263, | 47:56:271, | 35:56:259, | 43:56:267, |
| | 63:56:231, | 71:56:239, | 59:56:227, | 67:56:235, |
| | 279:56:447, | 287:56:455, | 275:56:443, | 283:56:451, |
| | 303:56:471, | 311:56:479, | 299:56:467, | 307:56:475, |
| | 319:56:487] | 327:56:495] | 315:56:483] | 323:56:491] |
| | DRU9 | DRU10 | DRU11 | DRU12 |
| | [−494:56:−270, | [−486:56:−262, | [−490:56:−266, | [−482:56:−258, |
| | −478:56:−254, | −470:56:−246, | −474:56:−250, | −466:56:−242, |
| | −454:56:−286, | −446:56:−278, | −450:56:−282, | −442:56:−274, |
| | −238:56:−70, | −230:56:−62, | −234:56:−66, | −226:56:−58,− |
| | −214:56:−46, | −206:56:−38, | −210:56:−42, | 202:56:−34, |
| | −198:56:−30, | −190:56:−22, | −194:56:−26, | −186:56:−18, |
| | 18:56:242, | 26:56:250, | 22:56:246, | 30:56:254, |
| | 34:56:258, | 42:56:266, | 38:56:262, | 46:56:270, |
| | 58:56:226, | 66:56:234, | 62:56:230, | 70:56:238, |
| | 274:56:442, | 282:56:450, | 278:56:446, | 286:56:454, |
| | 298:56:466, | 306:56:474, | 302:56:470, | 310:56:478, |
| | 314:56:482] | 322:56:490] | 318:56:486] | 326:56:494] |
| | DRU13 | DRU14 | DRU15 | DRU16 |
| | [−488:56:−264, | [−480:56:−256, | [−492:56:−268, | [−484:56:−260, |
| | −472:56:−248, | −464:56:−240, | −476:56:−252, | −468:56:−244, |
| | −448:56:−280, | −440:56:−272, | −452:56:−284, | −444:56:−276, |
| | −232:56:−64, | −224:56:−56, | −236:56:−68, | −228:56:−60, |
| | −208:56:−40, | −200:56:−32, | −212:56:−44, | −204:56:−36, |
| | −192:56:−24, | −184:56:−16, | −196:56:−28, | −188:56:−20, |
| | 24:56:248, | 32:56:256, | 20:56:244, | 28:56:252, |
| | 40:56:264, | 48:56:272, | 36:56:260, | 44:56:268, |
| | 64:56:232, | 72:56:240, | 60:56:228, | 68:56:236, |
| | 280:56:448, | 288:56:456, | 276:56:444, | 284:56:452, |
| | 304:56:472, | 312:56:480, | 300:56:468, | 308:56:476, |
| | 320:56:488] | 328:56:496] | 316:56:484] | 324:56:492] |
| 106-tone | DRU1 | DRU2 | DRU3 | DRU4 |
| DRU | [52-tone DRU1, | [52-tone DRU3, | [52-tone DRU5, | [52-tone DRU7, |
| | 52-tone DRU2, | 52-tone DRU4, | 52-tone DRU6, | 52-tone DRU8, |
| | −463, 457] | −459, 461] | −457, 463] | −461, 459] |
| | DRU5 | DRU6 | DRU7 | DRU8 (106DRU80_8) |
| | [52-tone DRU9, | [52-tone DRU11, | [52-tone DRU13, | [52-tone DRU15, |
| | 52-tone DRU10, | 52-tone DRU12, | 52-tone DRU14, | 52-tone DRU16, |
| | −462, 458] | −458, 462] | −456, 464] | −460, 460] |

In another example, the optimal LTF sequences for 52DRU80 may be constructed by combining the most common optimal sequence for 26DRU80, namely, LTF26DRU80_1 (such as in Table 38 (below) with the optimal sequence in Table 39, further below.

TABLE 38
Exemplary Optimal DRU LTF Sequences
for 26DRU80 (Tone Plan 5)

| Optimal | |
|---|---|
| Sequence Number | Optimal LTF Sequence |
| LTF26DRU80_1 | −1, −1, −1, −1, −1, 1, 1, −1, −1, −1, 1, −1, −1, |
| | 1, 1, 1, −1, 1, 1, −1, 1, −1, −1, −1, 1, −1 |
| LTF26DRU80_2 | −1, 1, 1, −1, 1, −1, 1, −1, 1, −1, 1, 1, −1, |
| | 1, −1, −1, −1, −1, −1, −1, 1, 1, −1, −1, −1, −1 |

TABLE 39
Exemplary Optimal DRU Component LTF
Sequences for 52DRU80 for Tone Plan 5

| Optimal | |
|---|---|
| Sequence Number | Optimal LTF Sequence |
| LTF26DRU80_3 | −1, −1, 1, −1, −1, 1, −1, −1, 1, −1, 1, −1, −1, |
| | 1, −1, 1, −1, 1, 1, 1, −1, −1, −1, 1, 1, 1 |

TABLE 40
Exemplary Optimal DRU LTF Sequences
for 52DRU80 for Tone Plan 5

| Optimal | |
|---|---|
| Sequence Number | Optimal LTF Sequence (Tone Plan 5) |
| LTF52DRU80_1 | {LTF26DRU80_1, LTF26DRU80_3} |

TABLE 41
Exemplary Optimal DRU LTF Sequence
Mapping for 52DRU80 for Tone Plan 5

| 52DRU80 | Optimal LTF Sequence (Tone Plan 5) |
|---|---|
| 1 (52DRU80_1) | LTF52DRU80_1 |
| 2 | LTF52DRU80_1 |
| 3 | LTF52DRU80_1 |
| 4 | LTF52DRU80_1 |
| 5 | LTF52DRU80_1 |
| 6 | LTF52DRU80_1 |
| 7 | LTF52DRU80_1 |
| 8 | LTF52DRU80_1 |
| 9 | LTF52DRU80_1 |
| 10 | LTF52DRU80_1 |
| 11 | LTF52DRU80_1 |
| 12 | LTF52DRU80_1 |
| 13 | LTF52DRU80_1 |
| 14 | LTF52DRU80_1 |
| 15 | LTF52DRU80_1 |
| 16 (52DRU80_16) | LTF52DRU80_1 |

In another example, the optimal LTF sequences for 106DRU80 may be constructed by combining sequences from Tables (such as Table 38 (above), Table 39 (above), and Table 42 (below) as listed in Table 43, further below.

TABLE 42
Exemplary Optimal DRU Component LTF Sequences
for 106DRU80 for Tone Plan 5

| Optimal | |
|---|---|
| Sequence Number | Optimal LTF Sequence |
| LTF26DRU80_4 | 1, −1, 1, −1, 1, −1, 1, 1, −1, 1, 1, 1, |
| | 1, −1, −1, −1, −1, 1, −1, −1, |
| | 1, −1, 1, −1, −1, 1 |
| LTF26DRU80_5 | 1, 1, −1, 1, 1, 1, 1, −1, 1, −1, −1, 1, 1, 1, −1, |
| | 1, −1, −1, 1, 1, −1, 1, −1, 1, 1, 1 |

TABLE 43
Exemplary Optimal DRU LTF Sequences
for 106DRU80 for Tone Plan 5

| Optimal | |
|---|---|
| Sequence Number | Optimal LTF Sequence |
| LTF106DRU80_1 | {LTF26DRU80_1, LTF26DRU80_3, |
| | LTF26DRU80_4, LTF26DRU80_5}, {1, −1} |

In an example, the optimal LTF sequences for 106DRU80 considering an exemplary tone plan 5 (such as in Table 37 (above)) is listed in Table 43, above, and the mapping of the optimal sequences to the eight 106DRU80s is listed in Table 44, below.

TABLE 44
Exemplary Optimal DRU LTF Sequence Mapping
for 106DRU80 for Tone Plan 5

| 106DRU80 | Tone Plan 5 |
|---|---|
| 1 (106DRU80_1) | LTF106DRU80_1 |
| 2 | LTF106DRU80_1 |
| 3 | LTF106DRU80_1 |
| 4 | LTF106DRU80_1 |
| 5 | LTF106DRU80_1 |
| 6 | LTF106DRU80_1 |
| 7 | LTF106DRU80_1 |
| 8 (106DRU80_8) | LTF106DRU80_1 |

In an example, the optimal component sequences corresponding to each tone plan for each distribution bandwidth may be stored individually such that they can be used to construct the LTF sequences for larger DRU sizes. In one example, the component LTF sequences for tone plan 1 of the 20 MHz distribution bandwidth are listed in Tables (such as Table 3, Table 5 and Table 8). In another example, the component LTF sequences for tone plan 2 of the 20 MHz distribution bandwidth are listed in Tables (such as Table 12, Table 14, and Table 17).

In an example, the mapping of the component LTF sequences or the constructed LTF sequence to certain DRUs may be stored such that each DRU is mapped to one (or more) component LTF sequence or one (or more) constructed LTF sequence. In one example, the mapping of the component LTF sequences for tone plan 1 of the 20 MHz distribution bandwidth is listed in Table 13 (for DRUs of size 26-tone), Table 16 (for DRUs of size 52-tone), and Table 19 (for DRUs of size 106-tone).

In an example, a non-AP STA determines a distribution bandwidth and a DRU allocation from a plurality of DRU allocations. Further, each of the plurality of DRU allocations includes respective subcarriers. Also, subcarriers of the determined DRU allocation are interleaved with subcarriers of one or more other DRU allocations of the plurality of DRU allocations, across the distribution bandwidth, and the determined DRU allocation includes 52 subcarriers. The STA transmits a frame, to an AP, in the determined DRU allocation, including a physical layer (PHY) preamble including a DRU LTF sequence, wherein the DRU LTF includes: −1, −1, −1, 1, 1, 1, −1, −1, −1, 1, −1, −1, −1, 1, −1, 1, 1, 1, −1, 1, 1, −1, 1, 1, −1, 1.

Additionally or alternatively, the −1, −1, −1, 1, 1, 1, −1, −1, −1, 1, −1, −1, −1, 1, −1, 1, 1, 1, −1, 1, 1, −1, 1, 1, −1, 1 may be a first component of the DRU LTF. Further, the determined DRU allocation may include 52 subcarriers. In an example, the frame may include a second component on a condition that the DRU allocation includes a first tone distribution pattern, a second tone distribution pattern, or a third tone distribution pattern. For example, the DRU allocation may be 52DRU20_1. Additionally or alternatively, the DRU allocation may be 52DRU20_2. Additionally or alternatively, the DRU allocation may be 52DRU20_3. Additionally or alternatively, the second component is: 1, −1, 1, −1, −1, 1, −1, 1, 1, −1, 1, 1, 1, −1, 1, 1, 1, 1, −1, 1, −1, −1, −1, 1, −1, −1.

Additionally or alternatively, on a condition that the DRU allocation includes a fourth tone distribution pattern, the DRU LTF includes: −1, −1, 1, 1, −1, −1, −1, 1, 1, −1, 1, 1, 1, 1, 1, 1, −1, −1, 1, −1, 1, 1, 1, −1, 1, −1 as a second component of the DRU LTF. For example, the DRU allocation may be 52DRU20_4.

Additionally or alternatively, the DRU allocation includes 26 subcarriers. Additionally or alternatively, the DRU allocation includes one of: a first tone distribution pattern (26DRU20_1), a second tone distribution pattern (26DRU20_2), a third tone distribution pattern (26DRU20_3), a fourth tone distribution pattern (26DRU20_4), a sixth tone distribution pattern (26DRU20_6), or a seventh tone distribution pattern (26DRU20_7). Additionally or alternatively, the DRU allocation includes 106 subcarriers and the DRU allocation includes a first tone distribution pattern (106DRU20_1) and a second tone distribution pattern (106DRU20_2).

In another example, the non-AP STA determines a distribution bandwidth and a DRU allocation from a plurality of DRU allocations in a tone plan. Further, each of the plurality of DRU allocations includes respective subcarriers. Also, subcarriers of the determined DRU allocation are interleaved with subcarriers of one or more other DRU allocations of the plurality of DRU allocations, across the distribution bandwidth. Moreover, the STA transmits a frame, to an AP, using the determined DRU allocation, the frame including a PHY preamble including a DRU LTF sequence. Further, the DRU LTF includes a first component and at least a second component of length 26. The first component of length 26 and the at least second component of length 26 are based on a size of the determined DRU allocation. The first component is a sequence of length 26 that is optimal for the most 26 tone distribution patterns in the tone plan. In examples, the size of the determined DRU allocation may be 26 tones, 52 tones or 106 tones.

Additionally or alternatively, the distribution bandwidth is 20 MHz. Additionally or alternatively, the distribution bandwidth is 40 MHz. Additionally or alternatively, the distribution bandwidth is 80 MHz.

Additionally or alternatively, the determined DRU allocation includes 52 subcarriers. Additionally or alternatively, the determined DRU allocation includes 106 subcarriers and the DRU LTF further includes a third component of length 26 and a fourth component of length 26. Additionally or alternatively, the DRU LTF includes: {1, −1}. Additionally or alternatively, the DRU LTF includes: {−1, −1}.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a non-access point (AP) station (STA), the method comprising:
determining a distributed resource unit (DRU) allocation from a plurality of DRU allocations, wherein each of the plurality of DRU allocations includes respective subcarriers; wherein subcarriers of the determined DRU allocation are interleaved with subcarriers of one or more other DRU allocations of the plurality of DRU allocations, across a distribution bandwidth of 20 Mhz; and
transmitting a frame, to an AP, using the determined DRU allocation, the frame including a physical layer (PHY) preamble including a DRU long training field (LTF) sequence, wherein the DRU LTF includes: −1, −1, −1, 1, 1, 1, −1, −1, −1, 1, −1, −1, −1, 1, −1, 1, 1, 1, −1, 1, 1, −1, 1, 1, −1, 1.

2. The method of claim 1, wherein the −1, −1, −1, 1, 1, 1, −1, −1, −1, 1, −1, −1, −1, 1, −1, 1, 1, −1, 1, 1, 1, −1, 1, 1, −1, 1 is a first component of the DRU LTF; and wherein the determined DRU allocation includes 52 subcarriers.

3. The method of claim 2, wherein, on a condition that the DRU allocation includes a first tone distribution pattern (52DRU20_1), a second tone distribution pattern (52DRU20_2) or a third tone distribution pattern (52DRU20_3), the DRU LTF further includes a second component of the DRU LTF, wherein the second components is: 1, −1, 1, −1, −1, 1, −1, −1, 1, 1, 1, −1, 1, 1, 1, 1, −1, 1, −1, −1, −1, 1, −1, −1.

4. The method of claim 2, wherein, on a condition that the DRU allocation includes a fourth tone distribution pattern (52DRU20_4), the DRU LTF further includes a second component of the DRU LTF, wherein the second components is: −1, −1, −1, 1, −1, 1, 1, 1, −1, −1, 1, 1, −1, −1, 1, −1, −1, −1, −1, −1, −1, 1.

5. The method of claim 1, wherein the DRU allocation includes 26 subcarriers and the DRU allocation includes one of: a first tone distribution pattern (26DRU20_1), a second tone distribution pattern (26DRU20_2), a third tone distribution pattern (26DRU20_3), a fourth tone distribution pattern (26DRU20_4), a sixth tone distribution pattern (26DRU20_6), or a seventh tone distribution pattern (26DRU20_7).

6. The method of claim 1, wherein the DRU allocation includes 106 subcarriers and the DRU allocation includes a first tone distribution pattern (106DRU20_1) and a second tone distribution pattern (106DRU20_2).

7. A method for use in a non-access point (AP) station (STA), the method comprising:
determining a distribution bandwidth and a distributed resource unit (DRU) allocation from a plurality of DRU allocations in a tone plan, wherein each of the plurality of DRU allocations includes respective subcarriers; wherein subcarriers of the determined DRU allocation are interleaved with subcarriers of one or more other DRU allocations of the plurality of DRU allocations, across the distribution bandwidth; and
transmitting a frame, to an AP, using the determined DRU allocation, the frame including a physical layer (PHY) preamble including a DRU long training field (LTF) sequence, wherein the DRU LTF includes a first component and at least a second component of length 26, the first component of length 26 and the at least second component of length 26 are based on a size of the determined DRU allocation, wherein the first component is a sequence of length 26 that is optimal for the most 26 tone distribution patterns in the tone plan.

8. The method of claim 7, wherein the distribution bandwidth is 20 MHz.

9. The method of claim 7, wherein the distribution bandwidth is 40 MHz.

10. The method of claim 7, wherein the distribution bandwidth is 80 MHz.

11. The method of claim 7, wherein the determined DRU allocation includes 52 subcarriers.

12. The method of claim 7, wherein the determined DRU allocation includes 106 subcarriers and the DRU LTF further includes a third component of length 26, and a fourth component of length 26.

13. The method of claim 12, wherein the DRU LTF further includes: {1, −1}.

14. The method of claim 12, wherein the DRU LTF further includes: {−1, −1}.

15. A non-access point (AP) station (STA) comprising:
a processor operatively coupled to a transceiver, the STA configured to:
determine a distributed resource unit (DRU) allocation from a plurality of DRU allocations, wherein each of the plurality of DRU allocations includes respective subcarriers; wherein subcarriers of the determined DRU allocation are interleaved with subcarriers of one or more other DRU allocations of the plurality of DRU allocations, across a distribution bandwidth of 20 Mhz; and
transmit a frame, to an AP, using the determined DRU allocation, the frame including a physical layer (PHY) preamble including a DRU long training field (LTF) sequence, wherein the DRU LTF includes: −1, −1, −1, 1, 1, 1, −1, −1, −1, 1, −1, −1, −1, 1, −1, 1, 1, 1, −1, 1, 1, −1, 1, 1, −1, 1.

16. The non-AP STA of claim 15, wherein the −1, −1, −1, 1, 1, 1, −1, −1, −1, 1, −1, −1, −1, 1, −1, 1, 1, 1, −1, 1, 1, −1, 1, 1, −1, 1 is a first component of the DRU LTF; and wherein the determined DRU allocation includes 52 subcarriers.

17. The non-AP STA of claim 16, wherein, on a condition that the DRU allocation includes a first tone distribution pattern (52DRU20_1), a second tone distribution pattern (52DRU20_2) or a third tone distribution pattern (52DRU20_3), the DRU LTF further includes a second component of the DRU LTF, wherein the second components is: 1, −1, 1, −1, −1, 1, −1, 1, 1, −1, 1, 1, 1, −1, 1, 1, 1, 1, −1, 1, −1, −1, −1, 1, −1, −1.

18. The non-AP STA of claim 16, wherein, on a condition that the DRU allocation includes a fourth tone distribution pattern (52DRU20_4), the DRU LTF further includes a second component of the DRU LTF, wherein the second components is: −1, −1, −1, 1, −1, 1, 1, 1, −1, −1, 1, 1, −1, −1, 1, −1, 1, −1, −1, 1, −1, −1, −1, −1, −1, 1.

19. The non-AP STA of claim 15, wherein the DRU allocation includes 26 subcarriers and the DRU allocation includes one of: a first tone distribution pattern (26DRU20_1), a second tone distribution pattern (26DRU20_2), a third tone distribution pattern (26DRU20_3), a fourth tone distribution pattern (26DRU20_4), a sixth tone distribution pattern (26DRU20_6), or a seventh tone distribution pattern (26DRU20_7).

20. The non-AP STA of claim 15, wherein the DRU allocation includes 106 subcarriers and the DRU allocation includes a first tone distribution pattern (106DRU20_1) and a second tone distribution pattern (106DRU20_2).
